(19) United States
(12) Patent Application Publication
(10) Pub. No.: US 2015/0087874 A1
(43) Pub. Date: Mar. 26, 2015

(54) Reactor and Method for Gasifying and/or Cleaning a Starting Material

(71) Applicants: Hartwig Schlueter, 34260 Kaufungen (DE); Adam Handerek, 43-300 Bielsko-Biala (PL)

(72) Inventor: Adam Handerek, Bielskp-Biala (PL)

(73) Assignees: Hartwig Schlueter, Kaufungen (DE); Adam Handerek, Bielsko-Biala (PL)

(21) Appl. No.: 14/394,580

(22) PCT Filed: Apr. 23, 2013
(86) PCT No.: PCT/EP2013/001222

§ 371 Date: Oct. 15, 2014

(30) Foreign Application Priority Data
Apr. 24, 2012 (DE) 10 2012 008 458.7

(51) Int. Cl. B01J 19/30; C10B 53/07; B01J 19/24; C10B 49/14

(52) U.S. Cl. CPC B01J 19/30; C10B 49/14; C10B 53/07; B01J 19/24; B01J 2219/30408; B01J 2219/30207
USPC 585/634; 422/198

(57) ABSTRACT

The invention relates to a reactor for gasifying and/or cleaning a starting material (12), especially for depolymerizing plastic material (12), wherein the reactor comprises: a reactor vessel (14) for receiving the starting material (12), especially the plastic material (12); a metal bath (26) which is arranged in the reactor vessel (14) and includes a liquid metallic material having a metal bath melting temperature (T_{Schmelz}); a plurality of filling elements (25) which are at least partially arranged in the metal bath (26); and a heater, especially an induction heater (18) for heating the starting material in the reactor vessel (14). According to the invention, a metal bath intermediate storage device (52) is provided and is connected to the reactor vessel (14) and is designed to remove at least part of the metal bath (26) from the reactor vessel (14) and to return the metal bath (26) to the reactor vessel (14), and comprises a delivery device (64) for delivering the metal bath (26), the delivery device (64) having a pressure increasing unit (60) by means of which the metal bath (26) can be delivered by applying the gas pressure (p).

The invention relates to a reactor for gasifying and/or cleaning a starting material, especially for depolymerizing plastic material, wherein the reactor comprises: (a) a reactor vessel for receiving the starting material, especially the plastic material; (b) a metal bath which is arranged in the reactor vessel and includes a liquid metallic material having a metal bath melting temperature; a plurality of filling elements which are at least partially arranged in the metal bath; and (d) a heater, especially an induction heater for heating the starting material in the reactor vessel. The invention also relates to a method for operating such a reactor.

WO 2010/130404 describes a reactor of this sort and a corresponding method: the purpose of the reactor is to depolymerize plastic material so it is easier to recycle.

DE 10 2010 002 704 A1 describes a device for the continuous pyrolysis of organic starting materials. The organic starting materials are transported through a tin bath, which has a temperature of around 480° C., thereby triggering the endothermic pyrolysis reaction. In order to prevent the liquid level in the tin bath from declining, the metal that has been transported out of the reactor with the solid materials may be transported back into the reactor by means of a metal feedback device. The device also has an opening for supplying additional external metals.

Residual materials are deposited during gasification or depolymerization, which stick to the filling elements. Therefore, it is generally necessary to clean the filling elements at regular intervals. With previous reactors, the removal of filling elements has been complex.

The invention aims to facilitate the cleaning of the filling elements.

The invention solves the problem by means of a reactor in accordance with the preamble with a metal bath intermediate storage device, which is connected to the reactor vessel and is designed to remove at least part of the metal bath from the reactor and to return the metal bath to the reactor vessel, and comprises a delivery device for delivering the metal bath, the delivery device having a pressure increasing unit by means of which the metal bath can be delivered by applying the gas pressure. Furthermore, the invention solves the problem by means of a method for operating such a reactor with the steps: (i) raising a metal bath gauge located in the metal bath, so that residual materials floating on the metal bath enter an overflow, (ii) removing the residual materials through the overflow and (iii) lowering the metal bath gauge of the metal bath.

The invention is advantageous in that only a small amount of structural elements of the reactor come into contact with the metal bath. Contrary to when pumps are used, it is not possible for any components to be damaged by solidifying metal. The simple structure of the metal bath intermediate storage device is also an advantage, as the energy required to deliver the metal bath can be supplied using gas pressure.

Within the scope of the present description, the term reactor should be understood in particular to mean a thermo-catalytic depolymerization reactor. This refers to a reactor which is designed to thermally and/or catalytically depolymerize polymers that have been introduced into the reactor, and/or to break them down into materials with a lower melting or boiling point. However, the reactor can also be designed to clean plastic material. The temperature in the reactor is then preferably selected such that the impurity disintegrates, but the plastic material remains unaffected.

The term heater should be understood to mean any device that is designed to supply the plastic material in the reactor vessel with heat energy. This may occur indirectly via the filling elements, preferably by means of induction.

It is preferable if the reactor vessel contains a starting material that it be gasified and/or cleaned which has a reaction temperature from which the starting material at least partially depolymerizes and/or vaporizes, the starting material having a carbonization temperature at which the starting material at least partially carbonizes, and wherein the metal bath melting temperature is higher than the reaction temperature and below the carbonization temperature. The reaction temperature should be especially understood to mean the temperature above which the starting material is gasified by at least 25% of its mass within one hour.

The carbonization temperature should be understood in particular to mean the temperature above which at least 3% of the starting mass remains at a reaction time of one day. This means that it is solid at the relevant temperature and therefore must be removed from the reactor as a solid.

The metal bath temperature of the metal bath is preferably above the reaction temperature and below the carbonization temperature, in particular between 350° C. and 600° C.

The term delivery device should be especially understood to mean any device by means of which the metal bath can be fully or partially removed from the reactor vessel and led back into it.

The term pressure increasing unit should be particularly understood to mean a device by means of which gas can be emitted, which is pressurized to such a degree that the metal bath can be delivered out of the reactor vessel and/or into the reactor vessel. The pressure increasing unit may, for example, have a pressurized gas store, as well as a gas cylinder. However, it is also possible that the pressure increasing unit has a pump which compresses gas. This aids the delivery process. In addition to this, it is conceivable that the pressure increasing unit comprises two chemical materials that react with one another during the development of gas.

In particular, the metal bath is made of Wood's metal, the Lipowitz alloy, the Newton alloy, the Lichtenberg alloy and/or an alloy that contains gallium and indium. In principle, the metal bath has a density of at least 9 grams per cubic centimetre, so that the starting material experiences a strong buoyant force. The metallic material has a melting temperature of at least 300° C. The melting temperature is preferably a maximum of 600° C.

It is preferable if the metal bath intermediate storage device comprises a metal bath vessel that is located at a distance from the reactor vessel. This metal bath vessel is designed such that it does not react with the metal bath and is not affected by the metal bath.

The reactor preferably comprises a removal pipe that is arranged centrally in the reactor vessel, through which the residual materials floating on the metal bath can be removed, the removal pipe comprising in particular a ferromagnetic pipe material. Residual materials may refer to organic or inorganic impurities of the starting material, for example, or reaction products, which must pass through the reactor vessel before they are fully gasified.

Due to the fact that residual material of this sort often has a higher melting temperature, it is advantageous if the removal pipe is warmer than the metal bath surrounding it. This can be achieved by using a ferromagnetic removal pipe. In particular, the pipe material may have a pipe material Curie temperature which is different by at least 10 Kelvins to a wall material Curie temperature of the reactor vessel and/or the filling element Curie temperature of the filling elements. In particular, the pipe material Curie temperature may be higher than the wall material Curie temperature and/or the filling element Curie temperature.

According to a preferred embodiment, the metal bath vessel is at least partially arranged underneath the reactor vessel, such that the metal bath can be at least partially drained. In this way, the metal bath can be easily removed from the reactor vessel.

It is especially beneficial if the pressure increasing unit is set up to increase the pressure, in particular the gas pressure, in the metal bath vessel, so that the metal bath can be pushed back into the reactor vessel. In this process, it is possible, but not necessary, that the metal bath can be pushed directly back into the reactor vessel. It is also possible that the metal bath intermediate storage device has a second or several more metal bath vessels into which the metal bath can be delivered. It is possible, but not necessary, that the metal bath vessel has a heater by means of which the metal bath can be heated. In principle, the duration of the metal bath's residence in the metal bath vessel is so short that it does not solidify.

The metal bath intermediate storage device preferably comprises a metal bath vessel that is initially partially arranged above the reactor vessel, such that the metal bath can be drained into the reactor vessel. In this case it is especially beneficial if the pressure increasing unit is set up to increase the pressure in the reactor vessel, so that the metal bath can be pressed into the metal bath vessel. However, it is also possible that the metal bath intermediate storage device has two metal bath vessels, one metal bath vessel being arranged in such a way that the metal bath can be drained from the reactor vessel into this first metal bath vessel, the metal bath intermediate storage device comprising at least a second metal bath vessel from which the metal bath can be drained into the reactor vessel. In this case, the pressure increasing unit is designed to increase the pressure in the first metal bath vessel, so that the metal bath can be pushed from the lower metal bath vessel into the upper metal bath vessel by means of gas pressure.

It is beneficial, but not necessary, if the volume of the at least one metal bath vessel is designed to completely receive the metal bath.

In the following, the invention will be explained in more detail with the aid of drawings. They show

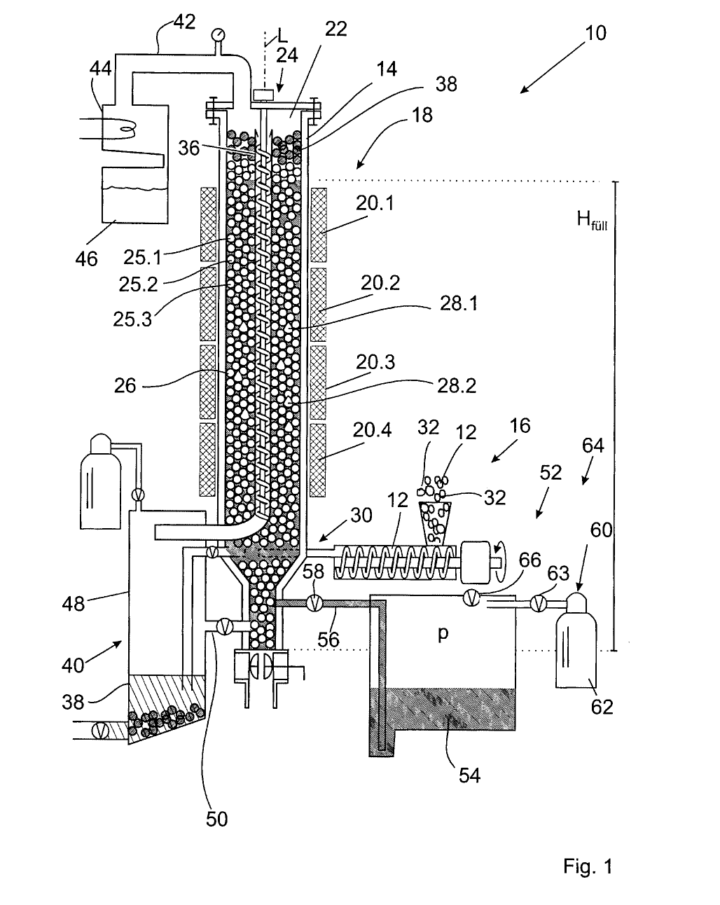

FIG. 1 a reactor according to the invention for conducting a method according to the invention according to a first embodiment and

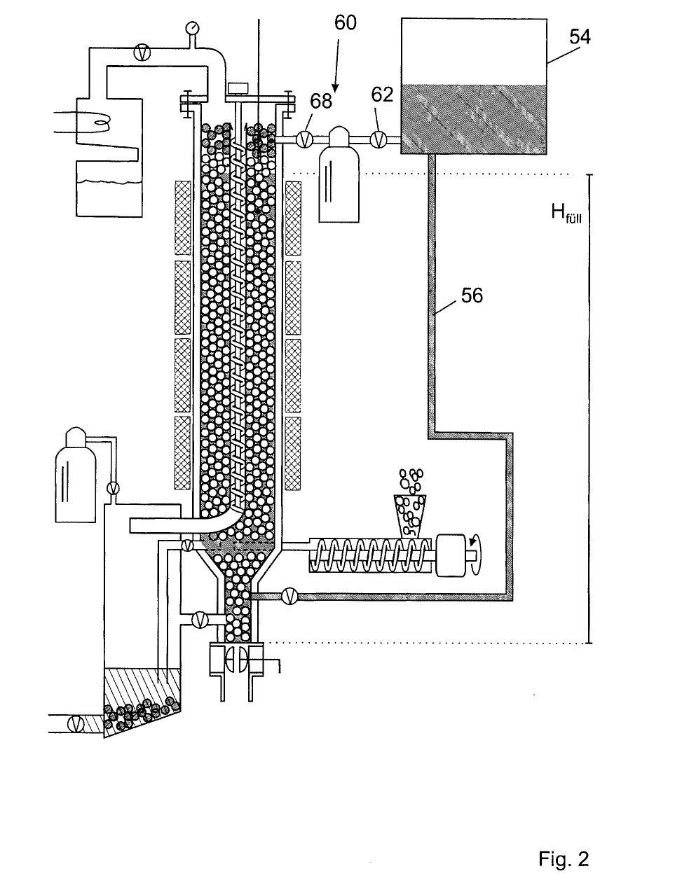

FIG. 2 a second embodiment of a reactor according to the invention for conducting a method according to the invention.

FIG. 1 shows a reactor 10 for gasifying a starting material in the form of plastic material 12, in particular polyolefin polymers. The reactor comprises, for example, an essentially cylindrical reactor vessel 14 for heating the plastic material 12, which is introduced into the reactor vessel 14 via an extruder 16.

The reactor 10 comprises a heater, for example an induction heater 18, which has a number of coils 20.1, 20.2, . . . , 20.4, by means of which an alternating magnetic field is created in an inner space 22 of the reactor vessel 14. The coils 20 (reference numbers without a suffix refer to all respective object) are connected with a power supply unit, not depicted, which induces an alternating current on the coils. The frequency f of the alternating current is, for example, in the region of 4 to 50 kHz. Higher frequencies are possible, but they lead to an increase in the so-called skin affect, which is undesirable.

A deceleration device 24 is arranged in the inner space 22 of the reactor vessel 14, by means of which the upward flow of liquefied plastic material 12 in the reactor vessel 14 can be slowed down. The deceleration device 24 comprises a number of movable filling elements 25.1, 25.2, . . . arranged in the inner space 22. These elements are made of ferromagnetic material and in the present invention take the form of spheres with a radius R. The sphere radius R may be between 0.5 and 50 millimetres, for example.

As a result of their ferromagnetic properties, the filling elements 25 are heated by the induction heater 18 and thereby heat a metal bath 26 made of liquid metal present in the reactor vessel 14. The specification that an object such as the filling elements is made of ferromagnetic material means that the object is ferromagnetic at a room temperature of 23° C.

The metal bath 26 has a melting point of T_{Schmelz}=300° C. and is introduced into the reactor vessel 14 to a metal bath gauge of H_{füll}. Along with the plastic material 12, the metal bath 26 fills at least part of the spaces of the filling elements 25. In principle, the metal bath 26 has a density of at least 9 grams per cubic centimetre, so that the plastic material 12 experiences a strong buoyant force. This buoyancy accelerates the plastic material 12. The filling elements 25 counteract this acceleration.

A temperature T prevails in the reactor vessel 14: this temperature is above a reaction temperature T_{R} at which the plastic material 12 gradually disintegrates. In this process, gas bubbles 28 are formed, which move upwards. The metal bath 26 can have a catalytic effect on the disintegration process, such that the reactor 10 may refer to a thermo catalytic depolymerisation reactor. The plastic material 12 introduced via the extruder 16 enters the inner space 22 through an entry opening 30, which is preferably located on the base of the reactor vessel 14.

The deceleration device 24 may comprise restraint devices, such as a grid stretched across a frame, whose mesh is so small that the filling elements 25 cannot move upwards through it. However, this is not necessary: in principle, the filling elements 25 are enough to produce a sufficiently large deceleration effect. The distribution of the filling elements 25, in the present case the spheres, is schematically depicted in FIG. 1.

As a result of their buoyancy, one part of the filling elements 25 floats in the metal bath 26 and another part is pressed into the metal bath 26 by filling elements 25 that are positioned further up. The filling elements 25 are also depicted in FIG. 1 in a constant radius R. It is possible that the filling elements have variable radii, wherein, for example, the radius R decreases in an upward direction.

In addition to this, FIG. 1 depicts a removal pipe 36 arranged in the reactor vessel 14, via which the residual material 38 floating on the metal bath can be removed. In the present case, the removal pipe 36 runs coaxially to a longitudinal axis L of the reactor vessel 14. The residual material 38 is, for example, impurities of the plastic material 12 and/or the additional catalyst 32 which can be introduced along with the plastic material 12.

The removal pipe 36 can be made of ferromagnetic pipe material with a pipe material Curie temperature T_{C,36}. As a result, the removal pipe 36 heats up to T_{C,36} when the induction heater 18 is driven with a sufficiently high power. The pipe material Curie temperature T_{C,36} may, for example, correspond to the filling element Curie temperature T_{C,25,1}: it may also be lower or higher. However, it is also possible that the removal pipe 36 is constructed using a non-ferromagnetic material, such as an austenitic steel or titan.

The reactor vessel 14 is constructed of a wall material on at least the side facing the inner space 22. The wall material may be ferromagnetic, for example iron or magnetic steel. Alternatively, the wall material may also be non-magnetic. If the wall material is ferromagnetic, it has a wall material Curie temperature T_{C,14}. This may be lower than the filling element Curie temperature T_{C,25}. In this case, the wall of the reactor vessel 14 is colder during operation than the filling elements 25.

The removal pipe 36 is part of a pollutant removal system 40. As typical impurities of the plastic material 12, such as sand, are lighter than the metal bath 26, they float and can be removed at the top. In addition, the pollutant removal system 40 comprises a settling tank 48 that collects residual material 38. The residual material 38 may contain not entirely depolymerized organic material, alongside inorganic material. The organic material floats on the inorganic material and can be lead back into the reactor vessel 14 through a recycling pipeline 50 on the bottom of the container. The reactor 10 also comprises a gas outlet 42 that flows into a condenser 44 and removes the resulting gas. The liquid material leaving the condenser 44 lands in a collector 46. The reactor described can be operated with, for example, waste oil as a starting material instead of plastic material, and then be used for waste oil recycling.

FIG. 1 also depicts a metal bath intermediate storage device 52 that comprises a metal bath vessel 54. The metal bath intermediate storage device 52 is connected to the reactor vessel 14 via a removal lead 56 on the bottom of the latter. Fundamentally, the metal bath 26 can be completely drained by opening a valve 58. This should be understood to mean that certain residues of the metal bath 26 remain in the reactor vessel 14, but that these residues only constitute a small fraction of the entire metal bath, for example less than 5%.

In addition, the metal bath intermediate storage device 52 comprises a pressure increasing unit 60, which has a gas canister 62 and a gas valve 63 in the present case. The gas valve 63 can be controlled electronically by means of a control unit, not depicted, so that the pressure p in the metal bath vessel 54 can be adjusted.

In the present case, the pressure increasing unit 60 and the removal lead 56 form a delivery device 64. In order to conduct a method according to the invention, a metal bath gauge, which is defined by the filling height H_{füll}, is raised, for example, by supplying the reactor vessel 14 with an increased flow of plastic material via an extruder 16. Alternatively, the pressure increasing unit 60 is activated, so that liquid metallic material is pushed through the removal lead 56 from the metal bath vessel 54 into the reactor vessel 14.

As a result of this, the metal bath gauge H_{füll} rises and residual material 38 floating on the metal bath 26 land in the overflow, which is made up of the removal pipe 36 in the current case. The metal bath gauge of the metal bath 26 is subsequently lowered, for example by opening a drain valve 66, such that the gas pressure p in the metal bath vessel sinks. If the valve 58 is opened, part of the metal bath 26 flows into the metal bath vessel 54.

In addition to his, a method according to the invention is conducted by initially directing the metal bath 26—this means the entire metal bath or only a part of it—from the reactor vessel 14 into the metal bath intermediate storage device 52, especially into the metal bath vessel 54. This is achieved by opening the valve 54, wherein the gas pressure p in the metal bath vessel 54 is lower than a pressure p₂₆ of the metal bath 26 at the bottom of the reactor vessel 14. The filling elements 25 are then removed and cleaned, or cleaned in the reactor vessel 14, without being removed. The metal bath 26 is then directed back from the metal bath vessel into the reactor vessel 14 by closing the drain valve 66, keeping the valve 58 open and applying gas pressure to the metal bath vessel 54. If a predetermined metal bath gauge is reached, the valve 58 is closed.

FIG. 2 depicts a further embodiment of a reactor according to the invention 10, wherein the metal bath vessel 54 is arranged above the reactor vessel 14, so that the metal bath 26 can be drained into the reactor container 14. It should also be recognised that the pressure increasing unit 60 is set up to increase the pressure p₁₄ in the reactor container 14 by opening a gas valve 68. Gas pressure can also be applied to the metal bath vessel 54 by opening the gas valve 62, such that the metal bath 26 present in the metal bath vessel 54 can be fully delivered into the reactor container 14 by raising the gas pressure p.

Reference list

| | |
|---|---|
| 10 | Reactor |
| 12 | Plastic material |
| 14 | Reactor vessel |
| 16 | Extruder |
| 18 | Induction heater |
| 20 | Coil |
| 22 | Inner space |
| 24 | Deceleration device |
| 25 | Filling elements |
| 26 | Metal bath |
| 28 | Gas bubble |
| 30 | Entry opening |
| 32 | Catalyst |
| 34 | Outer wall |
| 36 | Removal pipe/overflow |
| 38 | Residual material |
| 40 | Pollutant removal system |
| 42 | Gas outlet |
| 44 | Condenser |
| 46 | Collector |
| 48 | Settling tank |
| 50 | Recycling pipe |
| 52 | Metal bath intermediate |
| | storage device |
| 54 | Metal bath vessel |
| 56 | Removal pipe |
| 58 | Valve |
| 60 | Pressure increasing unit |
| 62 | Gas canister |
| 63 | Gas valve |
| 64 | Delivery device |
| 66 | Drain valve |
| 68 | Gas valve |
| χ | Magnetic susceptibility |
| f | Frequency |
| p | Gas pressure |
| L | Longitudinal axis |
| R | Sphere radius |
| H_{füll} | Flling height |
| T_{Schmelz} | Metal bath melting temperature |

1. A reactor for gasifying and/or cleaning a starting material (12), especially for depolymerizing plastic material (12), with
(a) a reactor vessel (14) for receiving the starting material (12), especially the plastic material (12),
(b) a metal bath (26) which
is arranged in the reactor vessel (14) and
includes a liquid metallic material having a metal bath melting temperature (T_{Schmelz}),
(c) a plurality of filling elements (25) which are at least partially arranged in the metal bath (26) and
(d) a heater, especially an induction heater (18) for heating the starting material in the reactor vessel (14),
characterized by
(e) a metal bath intermediate storage device (52), which
is connected to the reactor vessel (14),
is designed to remove at least part of the metal bath (26) from the reactor vessel (14) and to return the metal bath (26) to the reactor vessel (14), and
comprises a delivery device (64) for delivering the metal bath (26),
the delivery device (64) having a pressure increasing unit (60) by means of which the metal bath (26) can be delivered by applying the gas pressure (p).

2. The reactor according to claim 1, characterized by the fact that the metal bath intermediate storage device (52) comprises a metal bath vessel (54) that is arranged below the reactor vessel (14), so that the metal bath (26) can be at least partially drained into the metal bath vessel (54).

3. The reactor according to claim 2, characterized by the fact that the pressure increasing unit (60) is set up to increase a pressure, especially a gas pressure (p), in the metal bath vessel (54), so that the metal bath (26) can be pushed back into the reactor vessel (14).

4. The reactor according to claim 1, characterized by the fact that the metal bath intermediate storage device (52) comprises a metal bath vessel (54) that is arranged above the reactor vessel (14), such that the metal bath (26) can be drained into the reactor vessel (14).

5. The reactor according to claim 4, characterized by that fact that the pressure increasing unit (60) is set up to increase a pressure, especially the gas pressure (p), in the reactor vessel (14), such that the metal bath (26) can be pushed into the metal bath vessel (54).

6. A method for the operation of a reactor for gasifying and/or cleaning a starting material (12), especially for depolymerizing plastic material (12), which comprises
(a) a reactor vessel (14) for receiving the starting material (12), especially the plastic material (12),
(b) a metal bath (26), which
is arranged in the reactor vessel (14) and
includes a liquid metallic material having a metal bath melting temperature (T_{Schmelz}),
(c) a plurality of filling elements (25), especially made from a ferromagnetic material,
(d) a heater, especially an induction heater (18) for heating the starting material in the reactor vessel (14) and
(e) a metal bath intermediate storage device (52), which
is connected to the reactor vessel (14),
comprises a delivery device (64) for delivering the metal bath (26),
the delivery device (64) having a pressure increasing unit (60), with the steps:
(i) raising a metal bath gauge (H_{füll}) located in the metal bath (26), so that residual materials (38) floating on the metal bath (26) enter an overflow,
(ii) removing the residual materials through the overflow (36) and
(iii) lowering the metal bath gauge of the metal bath (26).

7. The method for the operation of a reactor (10) according to claim 1, characterised by the steps:
(i) delivering a metal bath (26) from the reactor vessel (14) into the metal bath intermediate storage device (52) and
(ii) delivering a metal bath (26) from the metal bath intermediate storage device (52) into the reactor vessel (14),
(iii) the delivery in step (i) and/or step (ii) being conducted by means of gas pressure (p).

8. The method according to claim 6, characterised by the fact that a metal bath has a temperature from 350° C. to 600° C.

9. The method according to claim 7, characterised by the fact that a metal bath has a temperature from 350° C. to 600° C.
